(19) United States
(12) Patent Application Publication
(10) Pub. No.: US 2014/0340982 A1
(43) Pub. Date: Nov. 20, 2014

(54) Magnetic Agitator and Method for Using the Same

(71) Applicants: Hubert Richard Keel, III, Denver, CO (US); Clifford Adam Schlecht, Denver, CO (US)

(72) Inventors: Hubert Richard Keel, III, Denver, CO (US); Clifford Adam Schlecht, Denver, CO (US)

(21) Appl. No.: 14/271,384

(22) Filed: May 6, 2014

Related U.S. Application Data
(60) Provisional application No. 61/820,162, filed on May 6, 2013.

(51) Int. Cl. B01F 7/00; B01F 1/00; B01F 13/08

(52) U.S. Cl. CPC B01F 7/00233; B01F 13/0818; B01F 1/0011
USPC 366/273

(57) ABSTRACT

Provided herein is a magnetic agitator, comprising a magnet, a body having a central axis; and a plurality of spines, each spine having a shaft and a termination, wherein the shaft smoothly transitions from the body; wherein the body and spines are adapted to enhance mixing when the agitator is stirred in a vessel.

### CROSS-REFERENCE

This application claims the benefit under 35 U.S.C. §119(e) of U.S. provisional application 61/820,162, filed May 6, 2013, and entitled “Magnetic Agitator and Method for Using the Same,” the disclosure of which is incorporated by reference in its entirety.

### TECHNICAL FIELD

The present disclosure relates to devices and methods related to dissolving or suspending solids into liquids. In particular, the present disclosure relates to a magnetic agitator, which facilitates dissolution of chemicals and biomolecules, such as proteins, into a liquid medium and methods for using the same.

### BACKGROUND

The standard magnetic stir bar with an octagonal cross-section and central ring is versatile, being easily scalable to the size of the vessel in which it's used, and ubiquitous, being found in nearly every chemical and biological lab around the world. These stir bars, however, fail to provide adequate stirring motion for dissolving or suspending poorly soluble chemicals or biomolecules with a tendency toward aggregation, especially for proteins. These stir bars also fail to maintain biphasic mixtures of two immiscible liquid media.

The foregoing examples of the related art and limitations related therewith are intended to be illustrative and not exclusive. Other limitations of the related art will become apparent to those of skill in the art upon a reading of the specification and a study of the drawings.

### SUMMARY

The present disclosure provides a magnetic agitator, which advantageously mixes chemicals and biomolecules, such as proteins, into a liquid medium, such as an aqueous medium, or mixes two or more liquid media together. The magnetic agitator comprises a body having a magnet and a central axis, and a plurality of spines distributed on the body of the agitator. The shaft of each spine smoothly extends from the body without forming a hard angle or crevice between the body and the spine. Likewise, the termination of the spine smoothly thickens in relation to the shaft. Optionally, one or more spines may also comprise a magnet in the termination. The body may further comprise a knob or process, which is useful for smashing aggregated powder, thus aiding its dissolution or suspension into the liquid medium.

The spines are distributed such that, when stirred with at least one solid or with at least one liquid medium, the magnetic agitator is matched with the general shape of the bottom of the vessel in which it is used. In some embodiments, the terminations of the spines form a locus of points describing a sphere, thus providing enhanced mixing motion when matched with a round-bottomed vessel, such as a round-bottomed flask, Dewar flask, test tube, or bomb. In other embodiments, the overall shape of the magnetic agitator is cylindrical, providing a magnetic agitator suitable for use in a flat-bottomed vessel, such as a beaker, carboy or Erlenmeyer flask. In still other embodiments, the overall shape of the magnetic agitator may be egg-shaped or pill-shaped, providing a magnetic agitator suitable for use in a vessel with a bottom that comes to a point, such as a pear-shaped flask or V-vial. A vortex may also be formed behind the forward or rotational progression of the magnetic agitator through the liquid medium. This mixing motion quickly and thoroughly distributes the solid into the medium or of two liquid media into each other, forming a homogeneous solution, suspension or emulsion.

The magnetic agitator may also be scaled such that it may be used in vessels of varying sizes. The magnetic agitator may be longer to accommodate a larger-bottomed vessel. The magnetic agitator may have a radius substantially matched with the radius or round-bottomed flask in which it is used, or to accommodate the joint size of the neck of the vessel without becoming stuck during insertion or retrieval. For example, a magnetic agitator may be used in a vial to aid dissolution of a medicament into a pharmaceutically acceptable carrier. An agitator may also be scaled so that it may aid the dissolution of dry buffer media into a multi-liter flask or carboy.

In further embodiments, there is also provided a method for using the magnetic agitator, comprising providing a magnetic agitator in a vessel containing at least one solid or liquid, contacting the vessel with a magnetic stir plate, and activating the stir plate to effect a stirring motion in the vessel. In still further embodiments, there is provided a method for making the agitator. The advantages provided by the agitator are similar on any scale, namely the nutritional or medical value of the solid is enhanced, concentration and dosages are more accurate dosing, beverages maintain a desirable texture, users avoid undue frustration, and cleaning time is reduced for the vessel used for mixing.

Additional embodiments and features are set forth in part in the description that follows, and in part will become apparent to those skilled in the art upon examination of the specification, or may be learned by the practice of the embodiments discussed herein. A further understanding of the nature and advantages of certain embodiments may be realized by reference to the remaining portions of the specification and the drawings, which forms a part of this disclosure.

### BRIEF DESCRIPTION OF THE DRAWINGS

The disclosure will be readily understood by the following detailed description in conjunction with the accompanying drawings, wherein like reference numerals designate like structural elements. The drawings provide exemplary embodiments or aspects of the disclosure and do not limit the scope of the disclosure.

FIG. 1 shows a first perspective view of a first embodiment of the magnetic agitator. The magnetic agitator comprises an egg-shaped body having a magnet, a central axis, and seventeen spines: one spine located at the apex of the narrow part of the body aligned with the central axis, and three sets of four spines, the set being radially distributed about the central axis in the shape of a square. Each set is offset by about 22° from neighboring set down the central axis. The apical spine is shorter than the radial spines. Each spine terminates with a knob that is wider than the shaft of the spine. The terminations describe a locus of points on a sphere.

FIG. 2 shows a second perspective view of the magnetic agitator from FIG. 1.

FIG. 3 shows a third perspective view of the magnetic agitator from FIG. 1.

FIG. 4 shows a side elevational view of the magnetic agitator from FIG. 1.

FIG. 5 shows a bottom plan view of the magnetic agitator from FIG. 1, where the bottom is the perspective looking down the wide part of the egg-shaped body.

FIG. 6 shows a top plan view of the magnetic agitator from FIG. 1, where the top is the perspective looking down the narrow part of the egg-shaped body.

FIG. 7 shows a first perspective view of a second embodiment of the magnetic agitator. The magnetic agitator comprises a cylindrical body having a magnet, a central axis, a top knob at a first end of the body, a bottom knob at a second end of the body, and nine spines. The spines are grouped into three sets of three, the sets being radially distributed about the central axis of the spine in the shape of a triangle. Each set is offset by about 40° from the neighboring set down the central axis.

FIG. 8 shows a second perspective view of the magnetic agitator from FIG. 7.

FIG. 9 shows a first side elevational view of the magnetic agitator from FIG. 7.

FIG. 10 shows a second side elevational view of the magnetic agitator from FIG. 7.

FIG. 11 shows a top plan view of the magnetic agitator from FIG. 7, where the top is the perspective looking down the top knob.

FIG. 12 shows a bottom plan view of the magnetic agitator from FIG. 7, where the bottom is the perspective looking down the bottom knob.

FIG. 13 shows a first perspective view of a third embodiment of the magnetic agitator. The magnetic agitator comprises an egg-shaped body having a magnet, a central axis, and eight spines in two sets of four spines, the set being radially distributed about the central axis in the shape of a square. Each set is offset by about 45° from neighboring set down the central axis. Each spine terminates with a knob that is wider than the shaft of the spine. The terminations describe a locus of points on a sphere.

FIG. 14 shows a second perspective view of the magnetic agitator from FIG. 13.

FIG. 15 shows a side elevational view of the magnetic agitator from FIG. 13.

FIG. 16 shows a top plan view of the magnetic agitator from FIG. 13.

FIG. 17 shows a bottom plan view of the magnetic agitator from FIG. 13.

FIG. 18 shows a first perspective view of a fourth embodiment of the magnetic agitator. The magnetic agitator comprises a spherical body having a central axis and eight, the spines being radially and asymmetrically distributed about the central axis. Each spine terminates with a knob that is wider than the shaft of the spine. At least one termination or the body contains a magnet. The terminations describe a locus of points on a sphere.

FIG. 19 shows a second perspective view of the magnetic agitator from FIG. 18.

FIG. 20 shows a third perspective view of the magnetic agitator from FIG. 18.

FIG. 21 shows a fourth perspective view of the magnetic agitator from FIG. 18.

FIG. 22 shows a fifth perspective view of the magnetic agitator from FIG. 18.

FIG. 23 shows a sixth perspective view of the magnetic agitator from FIG. 18.

### DETAILED DESCRIPTION

The present disclosure may be understood by reference to the following detailed description, taken in conjunction with the drawings as described above. It is noted that, for purposes of illustrative clarity, certain elements in various drawings may not be drawn to scale, may be represented schematically or conceptually, or otherwise may not correspond exactly to certain physical configurations of embodiments.

The body of the magnetic agitator may be any three-dimensional solid. For example, the body may be egg-shaped, ovoid, oviform, spherical, cylindrical, cubic, trapezoidal, tetrahedral, pyramidal, icosahedral, or dodecahedral. In some embodiments, the body comprises at least one magnet. In other embodiments, at least one spine of the magnetic agitator comprises a magnet. In some embodiments, the body is formed from a core comprising a rare earth magnet and a shell formed from a resistant thermoplastic, such as polytetrafluoroethylene (PTFE) or high-density polyethylene (HDPE).

The magnetic agitator comprises a plurality of spines radially distributed on the body about the central axis of the body. The spines may be singular, such as an apical spine aligned with the central axis, or may be grouped in sets, for example, in sets of two, of three, of four, of five, of six, of seven, or of eight. Within each set, the spines are arranged so that they are as far apart from each other and in the same planar cross-section. For example, a set of two is arranged along a straight line with an angle θ of 180° between the two spines. A set of three is triangularly arranged, or arranged in the shape of a triangle with an angle θ of about 120°. A set of four is squarely arranged, or arranged in the shape of a square with an angle θ of about 90°. A set of five is pentagonally arranged, or arranged in the shape of pentagon with an angle θ of about 72°. A set of six is hexagonally arranged, or arranged in the shape of a hexagon with an angle θ of about 60°. A set of seven is heptagonally arranged, or arranged in the shape of a heptagon with an angle θ of about 51.5°. A set of eight is octagonally arranged, or arranged in the shape of an octagon with an angle θ of about 45°. The spines may consist of one or more sets, for example, of two sets, three sets, four sets, five sets, or six sets of spines.

The number of spines on the body of the magnetic agitator can and will vary. In some embodiments, the body may have 3 to 49 spines, such as 3 to 5 spines, 5 to 9 spines, 8 to 21 spines, 9 to 11 spines, 11 to 14 spines, 13 to 21 spines, 13 to 17 spines, 14 to 25 spines, 25 spines to 33 spines, or 33 to 49 spines. In other embodiments, the body may have 5 to 33 spines. In particular embodiments, the body may have 8 spines. In some embodiments, the body may have 9 spines. In other embodiments, the body may have 11 spines. In still other embodiments, the body may have 13 spines. In other embodiments, the body may have more than 3 spines, such as more than 5 spines, more than 8 spines, or more than 11 spines. In other embodiments, the body may have less than 49 spines, such as less than 33 spines, or less than 13 spines.

When the spines consist of more than one set, each set is offset from a neighboring set down the central axis. In some embodiments, the spines may consist of 2 sets, 3 sets, 4 sets, 5 sets, 6 sets, 7 sets, 8 sets, 9 sets, or 10 sets. Typically, the offset is related to the geometric distribution within the set. For example, a set of two with a linear distribution is offset from a neighboring set by an angle φ of about 45°. A set of three with a triangular distribution is offset from a neighboring set by an angle φ of about 30°. A set of four with a square distribution is offset from a neighboring set by an angle φ of about 22.5°. A set of five with a pentagonal distribution is offset from a neighboring set by an angle φ of about 18°. A set of six with a hexagonal distribution is offset from a neighboring set by an angle φ of about 15°. Generally, the offset between neighboring sets is by a quarter the number of degrees that adjacent spines within the same set.

The apical spine may be shorter than the radial spines. In some embodiments, the terminations form a locus of points on a sphere, meaning that the length of each spine is selected so that the terminations end on this sphere. Each spine may terminate with a knob that is proportionally wider than the shaft of the spine. The knobby termination advantageously improves the mixing ability of the agitator and reduces the amount of powder caked on the agitator or the mixing vessel. The termination may also comprise a magnet. Alternatively, the magnetic agitator does not contain a magnet in the body but contains at least one magnet in one of the spines.

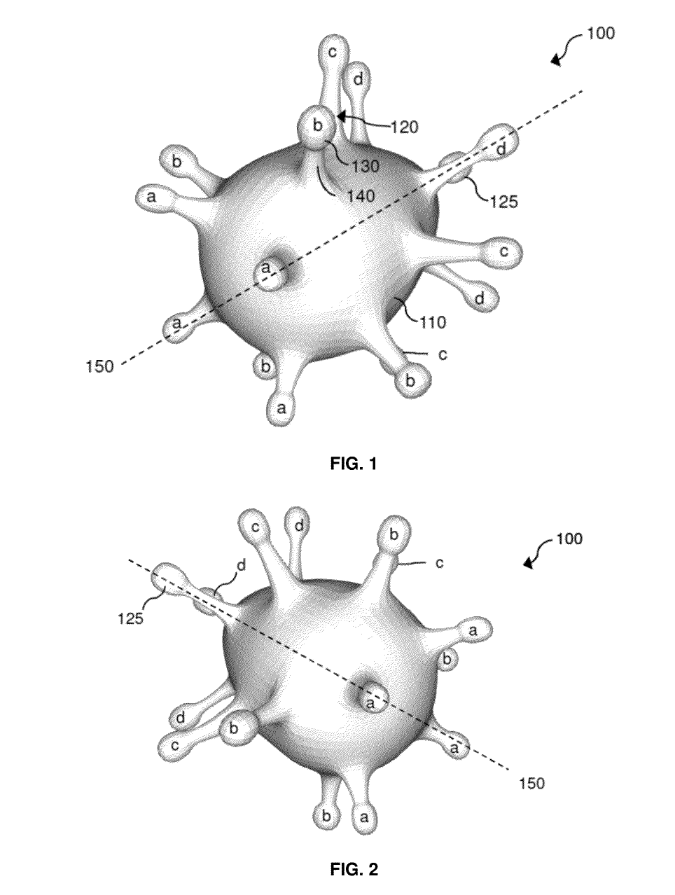

Referring to FIGS. 1-6, a first perspective view of a first embodiment of the magnetic agitator 100 is shown. The magnetic agitator 100 comprises an egg-shaped body 110 having a central axis 150 and seventeen spines 120,125: one spine 125 located at the apex of the narrow part 115 of the body 110 aligned with the central axis 150, and four sets a,b,c,d of four spines 120, the sets a,b,c,d being radially distributed about the central axis 150 in the shape of a square (angle θ of about 90°). Each set a,b,c,d is offset by an angle φ of about 22° from neighboring set a,b,c,d down the central axis 150. The apical spine 150 is shorter than the radial spines 120. Each spine 120,125 terminates with a knob 130 that is wider than the shaft 140 of the spine 120,125. The terminations (knobs 130) describe a locus of points on a sphere 170.

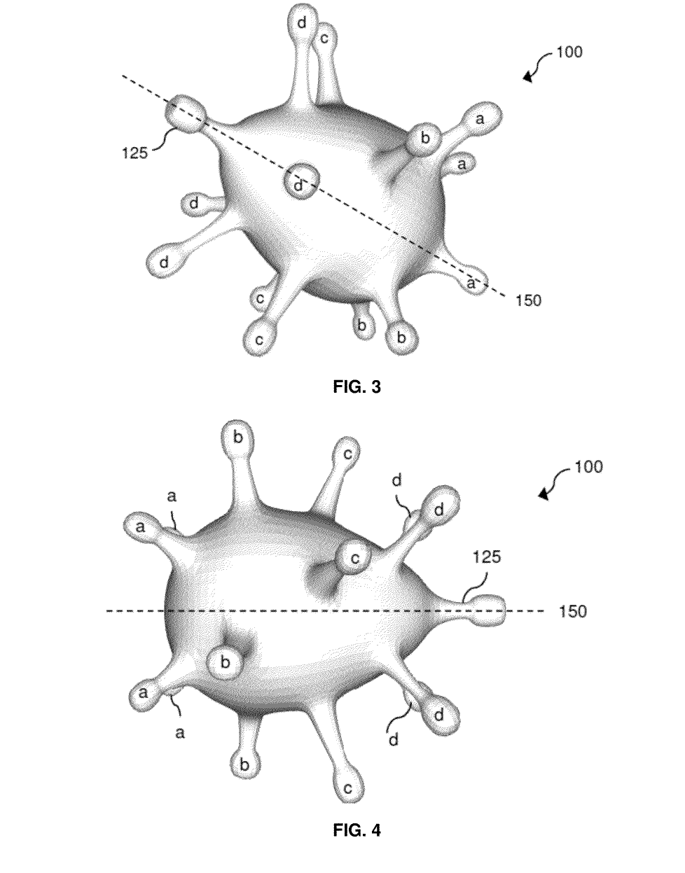

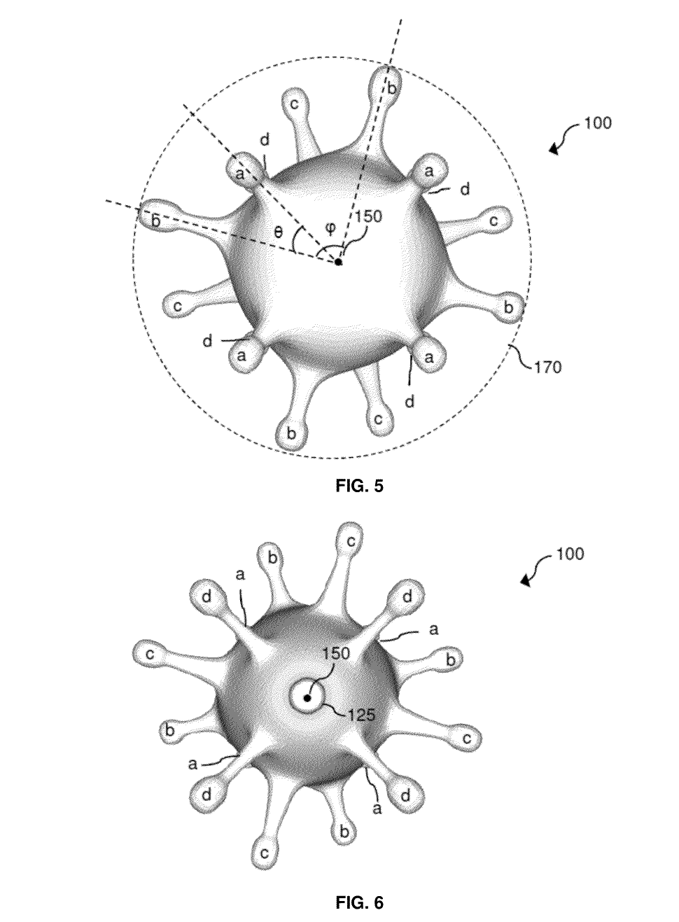

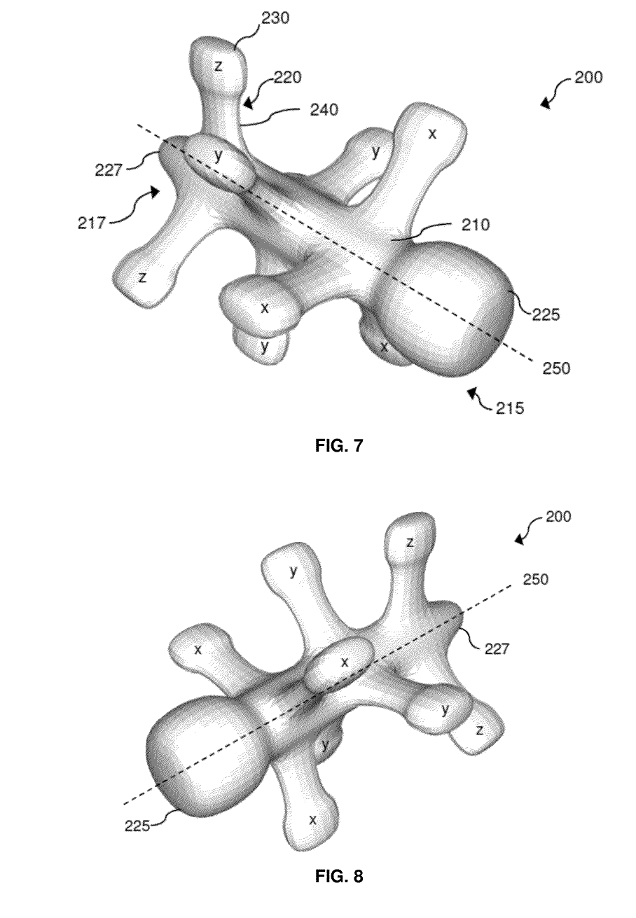

FIG. 2 shows a second perspective view of the magnetic agitator 100 from FIG. 1. FIG. 3 shows a third perspective view of the magnetic agitator 100 from FIG. 1. FIG. 4 shows a side elevational view of the magnetic agitator 100 from FIG. 1. FIG. 5 shows a bottom plan view of themagnetic agitator 100 from FIG. 1, where the bottom is the perspective looking down the wide part 127 of the egg-shaped body 110. FIG. 6 shows a top plan view of the magnetic agitator 100 from FIG. 1, where the top is the perspective looking down the narrow part 115 of the egg-shaped body 110.

Referring to FIGS. 7-12, a first perspective view of a second embodiment of the magnetic agitator 200 is shown. The magnetic agitator 200 comprises a cylindrical body having a central axis 250, a top knob 225 at a first end of the body 215, a bottom knob 227 at a second end of the body 217, and nine spines 220. The spines 220 are grouped into three sets x,y,z of three, the sets x,y,z being radially distributed about the central axis 250 in the shape of a triangle (angle θ of about 120°). Each set x,y,z is offset by an angle φ of about 40° from the neighboring set x,y,z down the central axis 250.

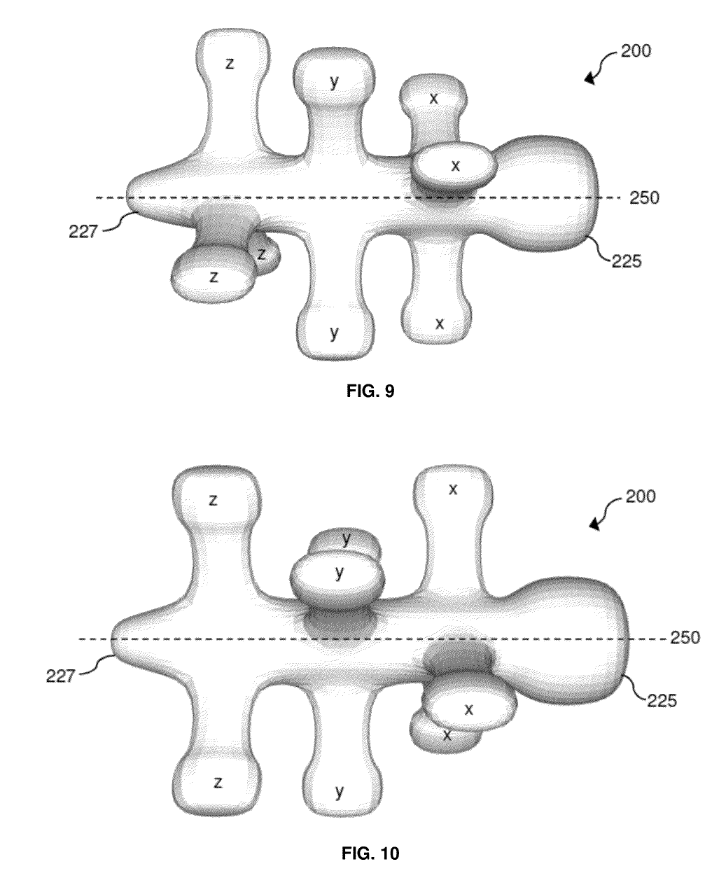

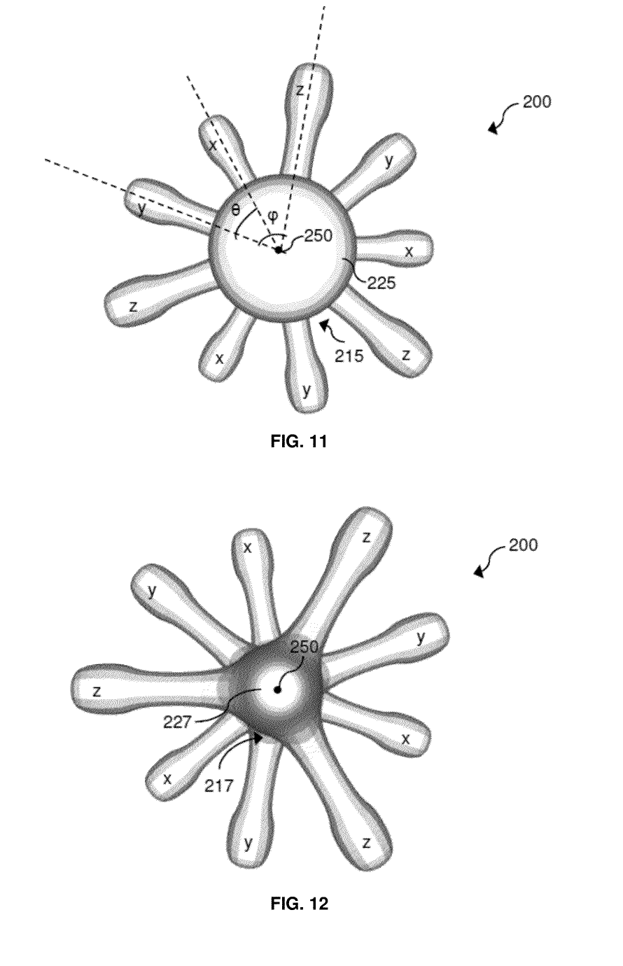

FIG. 8 shows a second perspective view of the magnetic agitator 200 from FIG. 7. FIG. 9 shows a first side elevational view of the magnetic agitator 200 from FIG. 7. FIG. 10 shows a second side elevational view of the magnetic agitator 200 from FIG. 7. FIG. 11 shows a top plan view of the magnetic agitator 200 from FIG. 7, where the top is the perspective looking down the top knob 225. FIG. 12 shows a bottom plan view of the magnetic agitator 200 from FIG. 7, where the bottom is the perspective looking down the bottom knob 227.

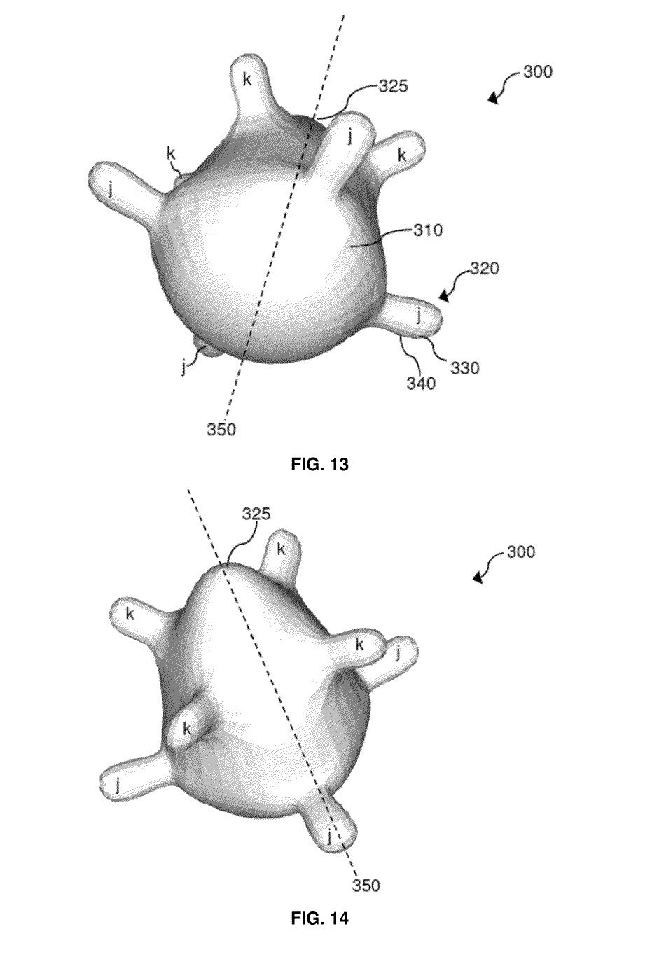

Referring to FIGS. 13-17, a first perspective view of a third embodiment of the magnetic agitator 300 is shown. The magnetic agitator 300 comprises an egg-shaped body 310 having a central axis 350 and eight spines 320 in two sets j,k of four spines 320, the sets j,k being radially distributed about the central axis 350 in the shape of a square (angle θ of about) 90°. Each set j,k is offset by an angle φ of about 45° from neighboring set j,k down the central axis 350. Each spine 320 terminates with a knob 330 that is wider than the shaft 340 of the spine 320. The terminations (knobs 330) describe a locus of points on a sphere 370.

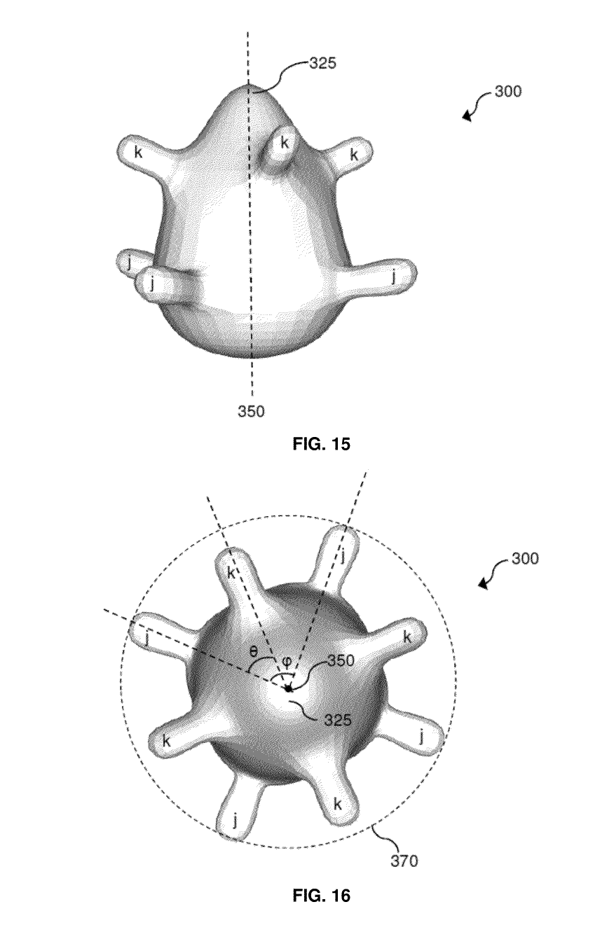

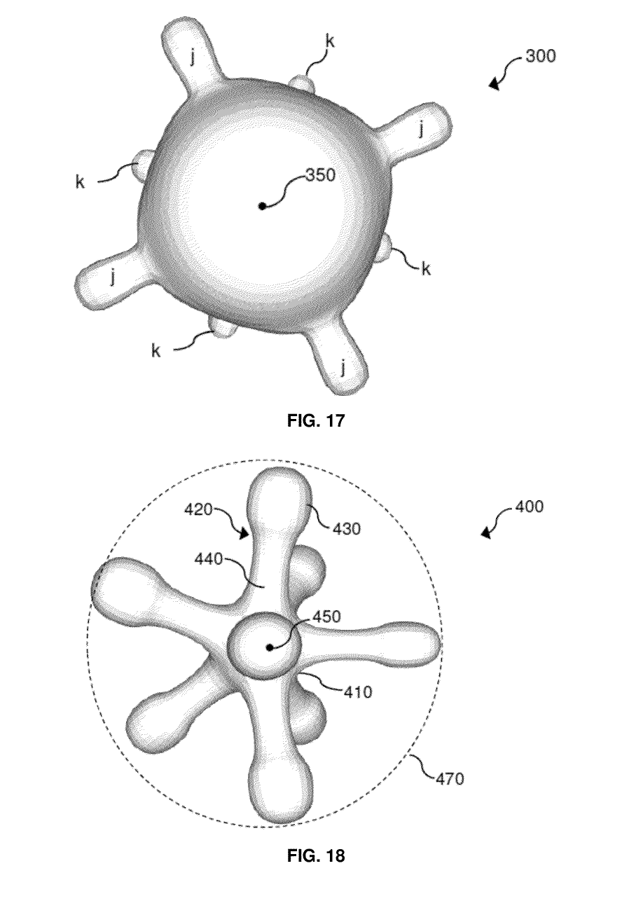

FIG. 14 shows a second perspective view of the magnetic agitator 300 from FIG. 13. FIG. 15 shows a side elevational view of the magnetic agitator 300 from FIG. 13. FIG. 16 shows a top plan view of the magnetic agitator 300 from FIG. 13. FIG. 17 shows a bottom plan view of the magnetic agitator 300 from FIG. 13.

Referring to FIGS. 18-22, a first perspective view of a fourth embodiment of the magnetic agitator 400 is shown. The magnetic agitator 400 comprises a spherical body 410 having a central axis 450 and eight spines 420, radially and asymmetrically distributed about the central axis 450. Each spine 420 terminates with a knob 430 that is wider than the shaft 440 of the spine 420. The terminations (knobs 430) describe a locus of points on a sphere 470.

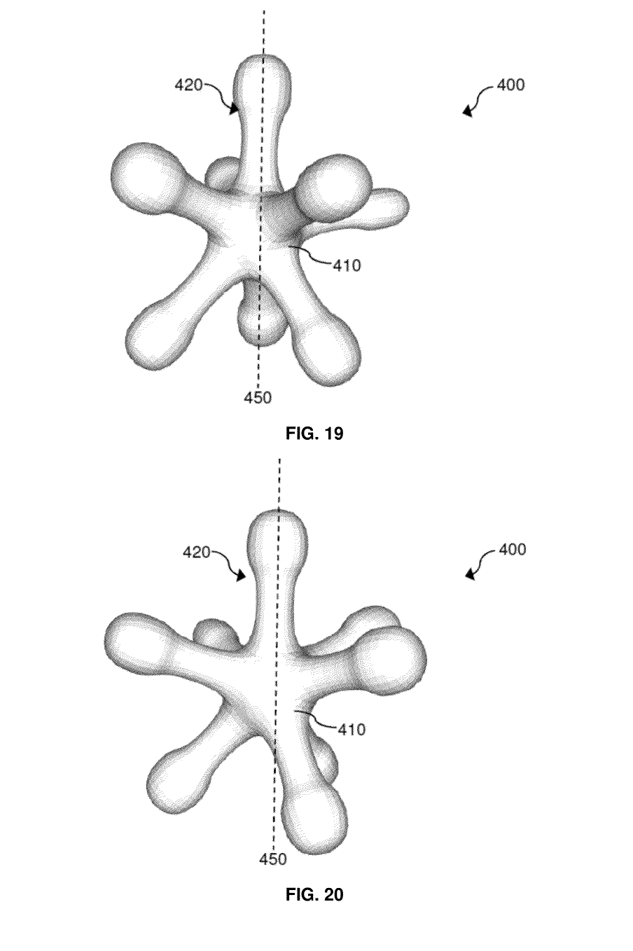

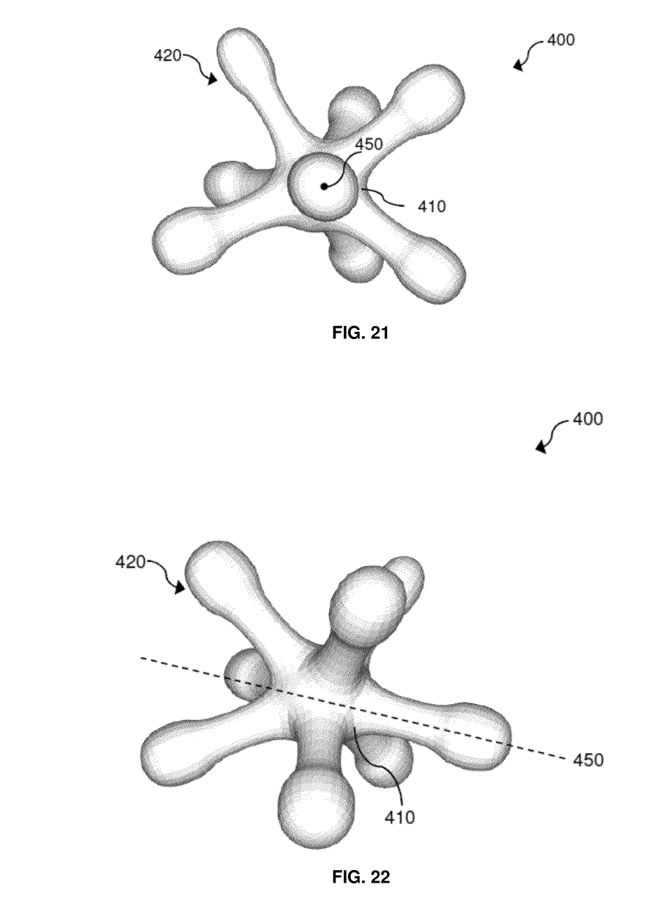

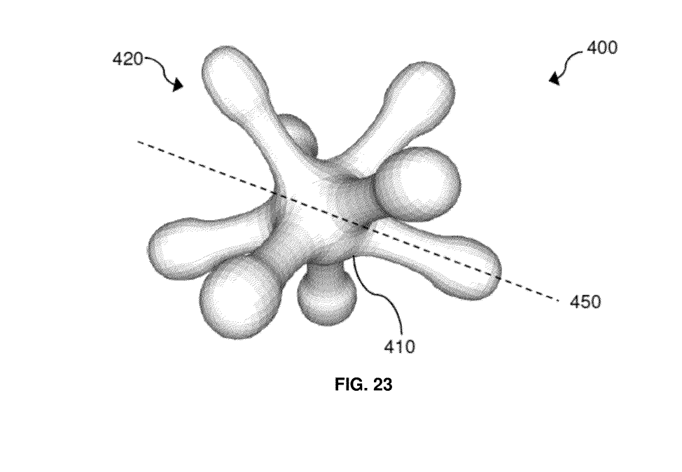

FIG. 19 shows a second perspective view of the magnetic agitator 400 from FIG. 18 FIG. 20 shows a third perspective view of the magnetic agitator 400 from FIG. 18. FIG. 21 shows a fourth perspective view of the magnetic agitator 400 from FIG. 18. FIG. 22 shows a fifth perspective view of the magnetic agitator 400 from FIG. 18. FIG. 23 shows a sixth perspective view of the magnetic agitator 400 from FIG. 18.

“Liquid medium” includes solvents, such as water or an organic solvent. Generally, the organic solvent is defined as a carbon-containing chemical that is capable of dissolving a solid, liquid, or a gas. Although one skilled in the art will appreciate that a wide variety of solvents may be incorporated into the current disclosure, suitable solvents for the present disclosure are those that contain no water and no reactive groups such as hydroxyl or amine groups. These solvents include, but not limited to, for example, aromatic hydrocarbons; aliphatic hydrocarbons, such as, hexane, heptane, benzene, toluene, branched-chain alkanes (isoparaffins); halogenated hydrocarbons; esters, such as methyl acetate, n-butyl acetate, tert-butyl acetate, isobutyl acetate, sec-butyl acetate, ethyl acetate, amyl acetate, pentyl acetate, 2-methyl butyl acetate, isoamyl acetate, n-propyl acetate, isopropyl acetate, ethylhexyl acetate; ketones, such as acetone or methyl ethyl ketone; ethers, such as tetrahydrofuran, dibutyl ether; and mono- and polyalkylene glycol dialkyl ethers (glymes) or mixtures of these solvents may be used.

Also provided herein is a method for mixing. The method comprises providing a system comprising an magnetic agitator, the agitator comprising a body having a magnet and a central axis, and a plurality of spines, each spine having a shaft and a termination. The system is contacted with at least one solid and at least one liquid medium and stirring the magnetic agitator such that the solid distributes into the liquid medium. Examples of suitable systems comprise at least one reaction vessel, such as a beaker or flask, and a magnetic stir plate. In other words, in some embodiments, the magnetic agitators may be adapted to be stirred by a stir plate.

Further, there is provided a method for making a magnetic agitator. The method comprises shaping a shell around a magnetic core to form the magnetic agitator, wherein the magnetic agitator comprises a body having a central axis and the magnetic core, and a plurality of spines, each spine having a shaft and a termination. In some embodiments, the magnetic agitator may be shaped by molding or three-dimensional printing.

The use of the word “a” or “an” when used in conjunction with the term “comprising” in the claims or the specification means one or more than one, unless the context dictates otherwise. The term “about” means the stated value plus or minus the margin of error of measurement or plus or minus 10% if no method of measurement is indicated. The use of the term “or” in the claims is used to mean “and/or” unless explicitly indicated to refer to alternatives only or if the alternatives are mutually exclusive. The terms “comprise”, “have”, “include” and “contain” (and their variants) are open-ended linking verbs and allow the addition of other elements when used in a claim.

From the preceding description of various embodiments of the present invention, it is evident that the objects of the invention are attained. Although the invention has been described and illustrated in detail, it is to be clearly understood that the same is intended by way of illustration and example only and is not to be taken by way of limitation. Accordingly, the spirit and scope of the invention are to be limited only by the terms of the appended claims.

What is claimed is:

1. A magnetic agitator, comprising:
a magnet,
a body having a central axis; and
a plurality of spines, each spine having a shaft and a termination, wherein the shaft smoothly transitions from the body;
wherein the body and spines are adapted to enhance mixing when the agitator is stirred in a vessel.

2. The magnetic agitator of claim 1, wherein the body is egg-shaped.

3. The magnetic agitator of claim 1, wherein the plurality of spines comprises 8 to 21 spines.

4. The magnetic agitator of claim 1, wherein the plurality of spines are radially distributed about the central axis.

5. The magnetic agitator of claim 4, wherein the radially distributed spines are grouped into sets.

6. The magnetic agitator of claim 5, wherein at least one set contains four spines.

7. The magnetic agitator of claim 5, wherein at least one set is in the shape of a square.

8. The magnetic agitator of claim 5, wherein each set is offset by about 10° to about 45° from the neighboring set down the central axis.

9. The magnetic agitator of claim 5, wherein the plurality of spines comprises at least three sets.

10. The magnetic agitator of claim 2, wherein the plurality of spines comprises one spine located at the apex of the narrow part of the egg-shaped body aligned with the central axis, and four sets of four spines, each set being radially distributed about the central axis in the shape of a square.

11. The magnetic agitator of claim 10, wherein each set is offset by about 22° from a neighboring set down the central axis.

12. The magnetic agitator of claim 10, wherein the apical spine is shorter than at least one of the radial spines.

13. The magnetic agitator of claim 1, wherein each spine termination is a knob that is proportionally wider than the shaft of the spine.

14. The magnetic agitator of claim 1, wherein the body is cylindrical.

15. The magnetic agitator of claim 14, wherein the cylindrical body further comprises a top knob at a first end of the body and a bottom knob at a second end of the body, wherein the top knob is larger in circumference than the bottom knob.

16. The magnetic agitator of claim 14, wherein the plurality of spines is nine spines.

17. The magnetic agitator of claim 14, wherein the plurality of spines are radially distributed about the central axis.

18. The magnetic agitator of claim 17, wherein the radially distributed spines are grouped into sets.

19. The magnetic agitator of claim 18, wherein at least one set contains three spines.

20. The magnetic agitator of claim 18, wherein each set is offset by about 10° to about 45° from a neighboring set down the central axis.
